(19) United States
(12) Patent Application Publication
(10) Pub. No.: US 2025/0339944 A1
(43) Pub. Date: Nov. 6, 2025

(54) METHOD FOR OPERATING A MOTOR-ACTUATED TOOL AND MOTOR-ACTUATED TOOL

(71) Applicant: GUSTAV KLAUKE GMBH, Remscheid (DE)

(72) Inventor: Egbert FRENKEN, Heinsberg (DE)

(73) Assignee: GUSTAV KLAUKE GMBH, Remscheid (DE)

(21) Appl. No.: 18/867,645

(22) PCT Filed: Jun. 12, 2023
(86) PCT No.: PCT/EP2023/065654

§ 371 Date: Nov. 20, 2024

(30) Foreign Application Priority Data
Jun. 10, 2022 (DE) 10 2022 114 696.0
Oct. 21, 2022 (DE) 10 2022 127 811.5

(51) Int. Cl. B25B 27/02; B25B 27/10; B25F 5/00

(52) U.S. Cl. CPC B25B 27/026; B25B 27/10; B25F 5/005

(57) ABSTRACT

The described solution pertains to a motor-actuated tool and a method for operating same. A certain working process requires an increase of an applied force to a certain working force. A hydraulic medium located in a piston/cylinder of the tool applies the force and the working process no longer requires any higher force after the certain working force has been reached. The tool allows an increase of the force to a general working force that exceeds the certain working force. Reaching the certain working force results in a characteristic change of the pressure increase in the hydraulic medium. Upon reaching the characteristic change, the return valve is initially opened and a pressure drop in the hydraulic medium, which occurs as a result of opening the return valve, is used as a signal for deactivating the motor, wherein a control of the tool is designed accordingly.

### TECHNICAL FIELD

The disclosure first of all pertains to a method for operating a motor-actuated tool with a hydraulic piston/cylinder arrangement, in which a hydraulic medium is located, wherein a working process is carried out and a certain working process requires an increase of an applied force to a certain working force, wherein the hydraulic medium is used for applying the force and the working process no longer requires any higher force after the certain working force has been reached, wherein the tool allows an increase of the force to a general working force that exceeds the certain working force, wherein reaching the certain working force results in a characteristic change of the pressure increase in the hydraulic medium, wherein a device for monitoring the pressure increase is provided and wherein reaching the characteristic change is used as a signal for terminating the certain working the certain working process after reaching force, but before reaching the general working force, and wherein the termination of the certain working process involves a deactivation of the motor used for the pressure increase in the hydraulic medium and opening of a return valve in order to allow the hydraulic medium to once again flow into a reservoir of the tool for another working process.

The disclosure furthermore pertains to a motor-actuated tool with a motor for carrying out a working process and with a piston/cylinder arrangement, in which a hydraulic medium is located, wherein a certain working process requires an increase of an applied force to a certain working force and the certain working process no longer requires any higher force after the certain working force has been reached, wherein the hydraulic medium is used for applying the force, wherein the tool allows an increase of the force to a general working force that exceeds the certain working force, wherein reaching the certain working force results in a characteristic change of the pressure increase in the hydraulic medium, wherein a device for monitoring the pressure increase is provided and wherein a control device furthermore is provided, wherein said control device uses reaching of the characteristic change as a signal for terminating the certain working process after reaching the certain working force, but before reaching the general working force, and wherein the control device causes, upon the termination of the certain working process, a deactivation of the motor used for the pressure increase in the hydraulic medium and opening of a return valve in order to allow the hydraulic medium to once again flow into a reservoir of the tool for another working process.

### PRIOR ART

WO 2017/129385 A1 (US 2019/0 030 698 A1) discloses a method for operating a motor-actuated tool, in which the detection of the characteristic change is used as a signal for terminating the certain working process after reaching the certain working force, but before reaching the general working force. A corresponding tool is also disclosed in this publication. With respect to the prior art, we furthermore refer to WO 2016/0 058 381 A1 (US 2017/0 087 709 A1), which discloses a comparable tool.

WO 2018/001691 A1 (US 2020/0147772 A1 discloses a method for operating a motor-actuated tool and a corresponding tool, wherein the return valve is opened by blocking a line section upstream of the return valve after a preadjusted working pressure is reached.

### SUMMARY OF THE DESCRIPTION

Based on the above-described prior art, the described solution deals with the objective of advantageously carrying out the method for terminating the certain working process and of disclosing a suitable tool for this method.

With respect to the method, this objective is initially and essentially attained in that, upon reaching the characteristic change, the return valve is initially opened and a pressure drop in the hydraulic medium, which occurs as a result of opening the return valve, is used as a signal for deactivating the motor.

With respect to the tool, this objective is initially and essentially attained in that the control is designed in such a that, way upon reaching the characteristic change, the return valve is initially opened and the motor is deactivated due to a pressure drop in the hydraulic medium, which occurs as a result of opening the return valve.

The characteristic change occurs as a result of the contact between working parts of the tool, e.g. of pressing jaws. This results in a significantly higher rigidity, which in turn leads to the characteristic pressure increase.

The described method and the design of the described tool make it possible to immediately react to this with a pressure drop in the hydraulic medium, i.e. the hydraulic medium located in the piston/cylinder arrangement. Opening of the return valve results in such an immediate pressure drop. No additional pressure increase takes place in the hydraulic medium. A gentle mode of operation of the tool is thereby advantageously achieved.

The initially continuing operation of the motor, which may also take place for a comparatively very short period of time, serves for preparing the deactivation of the motor, which then does not have to take place when a maximum pressure is reached and at a high current value. This also results in a gentle characteristic with respect to the operation of the motor.

The motor typically serves for operating a pump, which in turn pumps the hydraulic medium into the piston/cylinder arrangement and thereby ensures the pressure increase in the course of a working process.

The pump may be realized, for example, in the form of a piston pump. In this case, individual pressure stages are adjusted and can be registered by a pressure sensor that respectively measures the pressure within very short time intervals, which may be as short as tenths of a second or milliseconds. Based on this, a first pressure stage, which is significantly lower than a preceding pressure stage, can already be used as a signal for also deactivating the motor when a pressure drop occurs as a result of opening the return valve.

Alternatively, the motor may also be deactivated after a fixed period of time that begins when the return valve is opened. This fixed period of time may also be comparatively short, e.g. as short as one tenth of a second or several tenths of a second and as long as one second.

In addition, a supplementary sensor for measuring the motor current of the electric motor may be provided. In this way, a certain drop of the motor current can be additionally used for deactivating the motor. The pressure drop in the hydraulic medium can be checked as to the fact whether it coincides with a corresponding and basically expected drop of the motor current. If applicable, the pressure drop in the hydraulic medium and the drop of the motor current can be used for deactivating the electric motor in accordance with an “AND” condition. Similarly, the aforementioned fixed period of time can also be incorporated. This may be realized, for example, in accordance with an “AND” condition such that a deactivation of the electric motor certainly does not take place until a predefined fixed period of time has—also—elapsed after the return valve was opened.

The characteristic change in a tool value, in this case a pressure value in the hydraulic medium after reaching the certain working force, but typically before reaching the general working force and regardless of whether the general working force is reached or not, is used for an individual termination of the working process without suffering a loss in quality of the working process, i.e. the desired completion of the working process. Since the characteristic change of the tool value, in this case the pressure value, is used for initiating a termination of the certain working process rather than an absolute tool value, each working process can be terminated individually once the action upon the article being processed has also been terminated.

A multitude of working processes accordingly may require a multitude of different pressures or forces, at which the respective (certain) working process is terminated. In extreme instances, each working process may be respectively terminated at a different pressure or a different force.

The working process may be, for example, a pressing operation. In this case, two pressing jaws usually are moved relative to one another and an article to be pressed or a combination of articles to the pressed is placed between said pressing jaws. A-first-increase of the working force occurs as long as the article or the articles is/are elastically and/or plastically deformed due to the movement of the pressing jaws toward one another. Once the jaws are moved together, an additional increase of the working force practically only leads to an “on-block movement” of the pressing jaws. Consequently, only the tool property itself, e.g. the inherent elasticity or rigidity of one or both pressing jaws, essentially acts as resistance against the additional increase of the working force. A changed—second—increase of the working force occurs with respect to this additional increase. The transition from the first increase to the second increase of the working force leads to the aforementioned characteristic change in the pressure increase.

Furthermore, we also refer to the information disclosed in the initially cited WO 2017/129 385 A1 (US 2019/0 030 698 A1).

Another embodiment of the method and the tool is characterized in that the return valve is opened blocking a line section of the tool, which with respect to a flow direction of the returning hydraulic medium is located upstream of the return valve, i.e. that this line section of the tool is realized in a blockable manner, and in that a pressure increase, which leads to opening of the return valve, is generated in the blocked line section due to the continuing operation of the motor, i.e. that this pressure increase can be generated in the tool. The line section can be blocked immediately once the characteristic change is reached, e.g. in a magnet-actuated manner. The tool may accordingly comprise a solenoid valve. Since the line section is at the same time the line section, through which the hydraulic medium is pumped into the hydraulic cylinder in order to act upon the hydraulic piston, an additional delivery of hydraulic medium into the hydraulic cylinder can be prevented immediately once the characteristic change is reached. Accordingly, the tool may be designed in such a way that an additional delivery of hydraulic medium into the hydraulic cylinder can be prevented once the characteristic change is reached. No additional pressure increase can take place in the hydraulic cylinder. However, a pressure increase in the blocked line section, in assignment to which the return valve is also arranged, takes place due to the continuing operation of the motor and therefore the continuing operation of the pump. As a result of this pressure increase, the return valve opens once the pressure required for opening the return valve is reached and the pressure in the blocked line section therefore significantly drops practically immediately. This pressure drop can then be used for opening the blockage of the line section such that hydraulic medium can collectively flow out of the hydraulic cylinder and the hydraulic piston can return into its starting position. With respect to further details, we also refer to the disclosed content of initially cited Wo 2018/0016911 (US 2020/0147772 A1), which is hereby fully incorporated into the present application.

### BRIEF DESCRIPTION OF THE DRAWINGS

The disclosed solution is described in greater detail below with reference to the attached drawings that, however, merely show an exemplary embodiment. In these drawings:

FIG. 1 shows a partially sectioned representation of a hydraulic hand-operated pressing tool;

FIG. 2 shows the pressing tool according to FIG. 1 after reaching a certain working force;

FIG. 3 shows a representation of the pressure increase in the hydraulic tool while carrying out a working process;

FIG. 3a shows a representation of the absolute pressure values reached in pressure stages as a function of the time, e.g. during a pressing operation according to FIG. 3;

FIG. 4 shows a section through a hydraulic hand-operated pressing tool with a certain design of the return valve;

FIG. 5 shows an enlarged detail of the region V-V in FIG. 4;

FIG. 6 shows a representation corresponding to FIG. 5 during a movement of a moving part of the tool into a working position;

FIG. 7 shows a representation corresponding to FIG. 6 with opened return valve and actuated pressure booster piston;

FIG. 8 shows an enlarged detail of the region VIII in FIG. 7;

FIG. 9 shows a representation of a tool with two jaws that can be pivoted relative to one another;

FIG. 10 shows another embodiment of the tool in the form of a representation according to FIG. 4;

FIG. 11 shows an enlarged representation of the region XI in FIG. 10 with non-blocked line section;

FIG. 12 shows a representation according to FIG. 11 with blocked line section and opened return valve; and

FIG. 13 shows a representation according to FIG. 12 after releasing the blockage and continuing return movement of the hydraulic piston.

### DESCRIPTION OF THE EMBODIMENTS

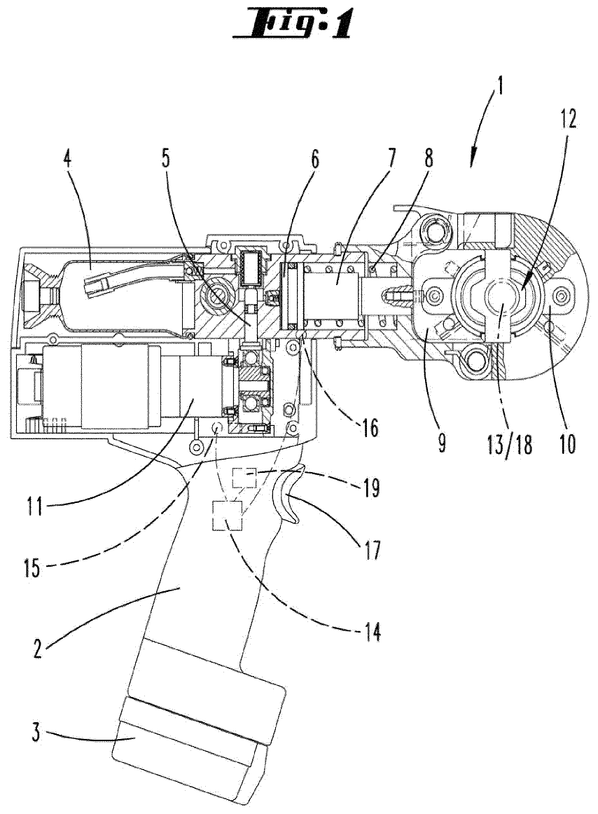

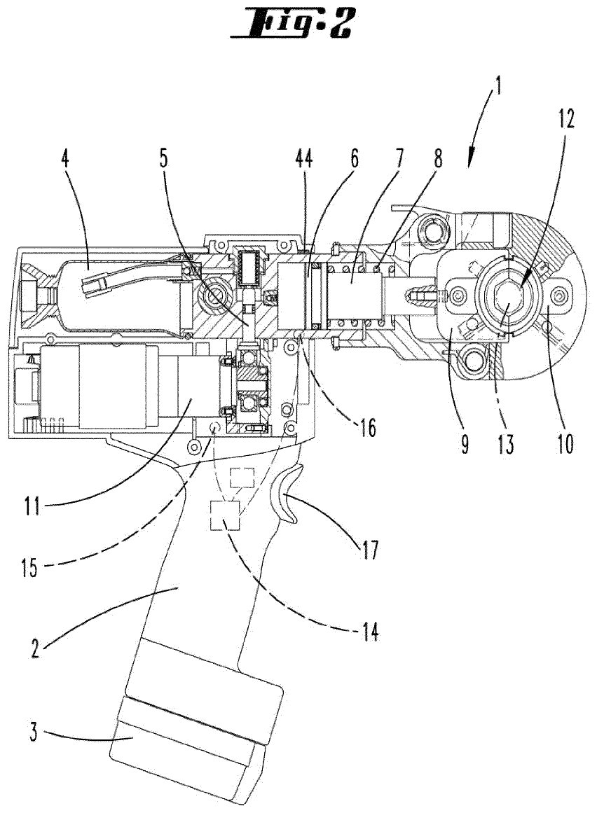

A tool in the form of a hydraulic hand-operated pressing tool 1 is initially described with reference to FIGS. 1 and 2. The hydraulic hand-operated pressing tool 1 may have a handle 2. It may furthermore have an accumulator 3 if it should be operated in a cordless manner. However, the power supply may also be realized by connecting the pressing tool to a power grid by an electric cable.

The hydraulic hand-operated pressing tool 1 may furthermore have a reservoir in the form of a hydraulic tank 4. Hydraulic medium can be pumped from the hydraulic tank 4 into a hydraulic cylinder 6 by a pump 5, e.g. a piston pump. A hydraulic piston 7 in the hydraulic cylinder 6 can be moved between a starting position and an end position by pumping the hydraulic medium into the hydraulic cylinder 6. The hydraulic piston 7 may be subjected to the action of a return spring 8.

In the exemplary embodiment, a movable working jaw 9, which may be a pressing jaw, can be displaced against a stationary working jaw 10, which may be another pressing jaw, due to the movement of the hydraulic piston 7. An article 13 to be pressed, which is composed, for example, of a sleeve and a pipe to be pressed together, can be accommodated in a pressing space 12. This may also concern an article 18 to be cut if the jaws 9, 10 are realized in the form of cutting jaws.

In other hydraulic hand-operated pressing tools, two movable working jaws could also be pivoted relative to one another, e.g. by the hydraulic piston 7, in order to carry out the pressing operation. In this respect, we refer, for example, to US 2011/0 247 506 A1.

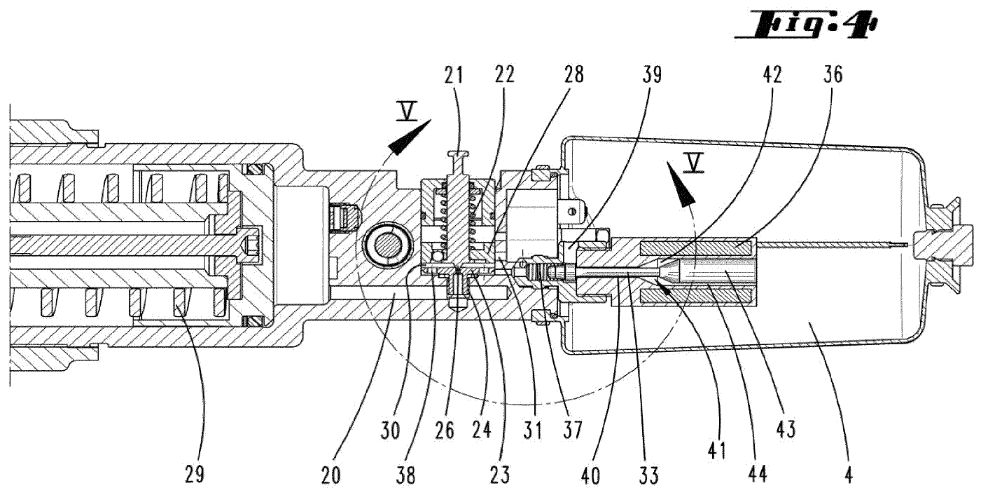

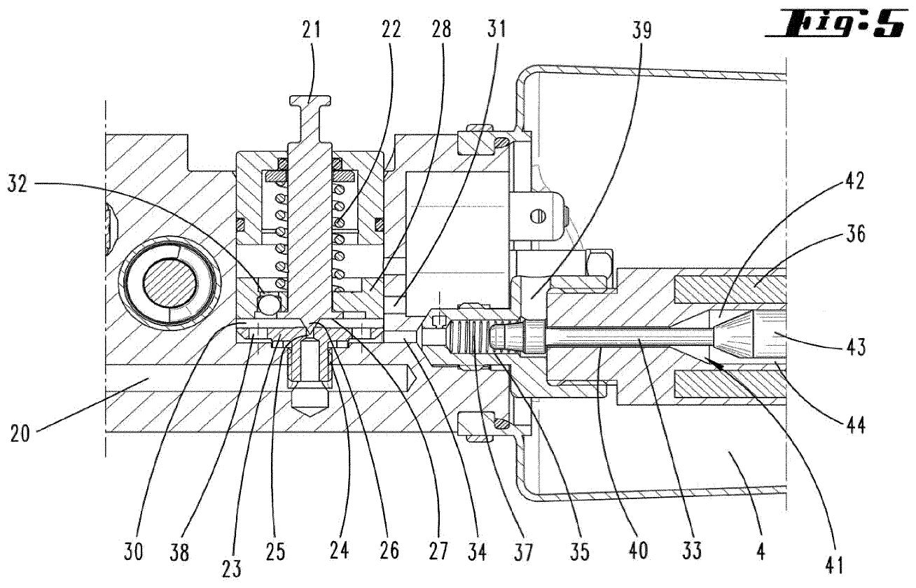

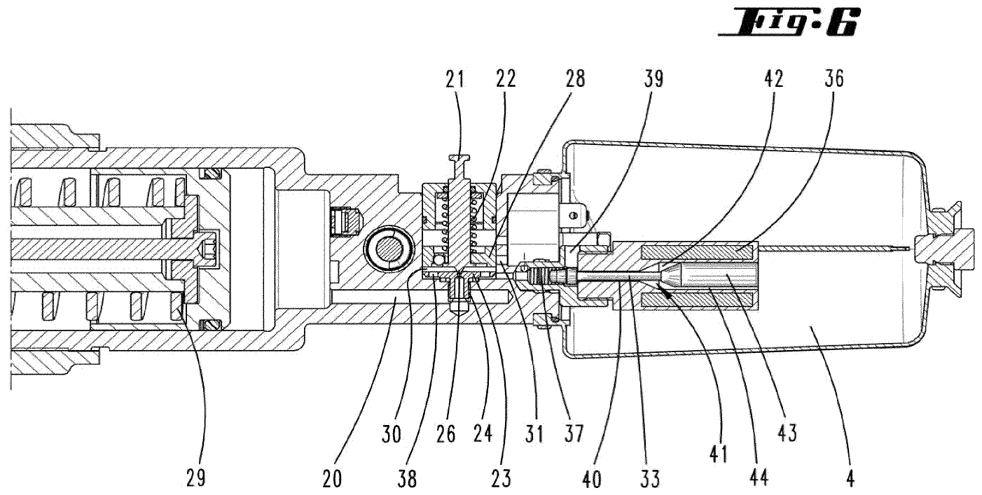

The pump 5 may be driven by an electric motor 11, the power supply of which can be realized with the aforementioned accumulator 3 or, for example, with the aforementioned power cable. Furthermore, a hydraulic hand-operated pressing tool according to FIG. 1 may have a suitable data processing device for evaluating transmitted measured values, wherein said data processing device is schematically represented by the reference numeral 14 in this case. Such a tool furthermore has a control device that is schematically represented by the reference numeral 19 in this case and connected to the data processing device 14 via corresponding lines. The functions of the data processing device 14 and the control device 19 may also be fulfilled in combination by a unified electronic component. The control device 19 can terminate a working process immediately and tool-autonomously. This can be realized, for example, with an embodiment of the type described below with reference to FIGS. 4 to 8.

The hydraulic hand-operated pressing tool 1 may likewise have a sensor 16 for measuring a pressure in the hydraulic medium and, if applicable, an additional sensor 15 for measuring the motor current of the electric motor 11. The pressure of the hydraulic medium can be measured by the sensor 16 in the hydraulic cylinder 6.

The sensor 15 for the motor current and/or the sensor 16 for the hydraulic pressure respectively deliver measured values within very short time intervals. These time intervals particularly are shorter than one second and may, for example, be shorter than one tenth of a second. Such a time interval may also amount to only one millisecond or several milliseconds.

The sensors particularly are electronic sensors that are supplied with electric energy, for example, by the accumulator 3.

A termination of the working process may consist of moving working parts such as a jaw of a pressing tool or a cutting edge of a cutting tool or a punching jaw of a punching tool back into a starting position or of initiating such a return movement. In a hydraulic pressing tool, the initiation particularly may consist of retracting the hydraulic piston 7 while hydraulic medium flows from the hydraulic cylinder back into the reservoir. A return valve is opened for this purpose. With respect to a special embodiment of such a hydraulic pressing tool, this is described: in greater detail below with reference to aforementioned FIGS. 4 to 8.

When carrying out a pressing operation in general with the hydraulic hand-operated pressing tool 1, the pressing operation is initiated, for example, by a hand-actuated switch 17 after the article 13 to be pressed was placed into the pressing space 12. The pump 5, which in the exemplary embodiment is a piston pump, then begins to pump hydraulic medium from the hydraulic tank 4 into the hydraulic cylinder 6 by carrying out multiple piston strokes.

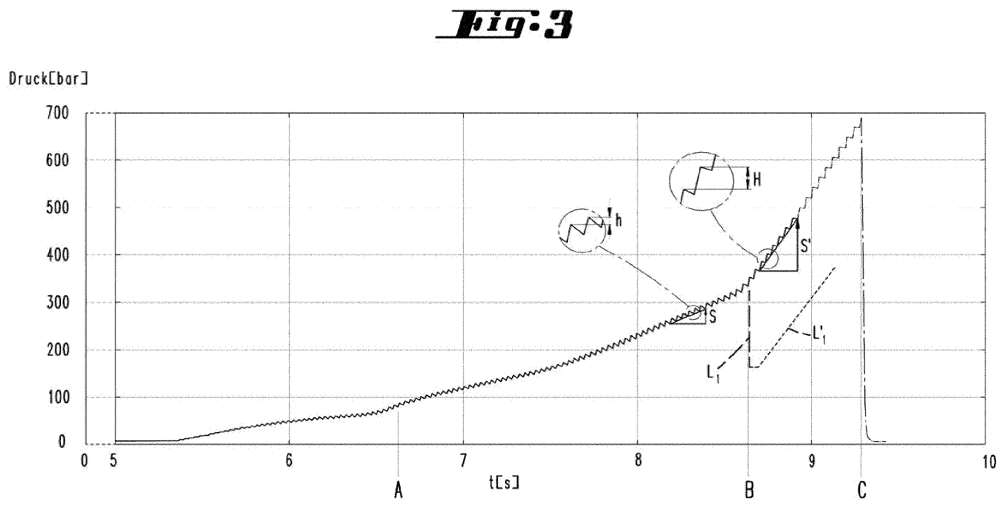

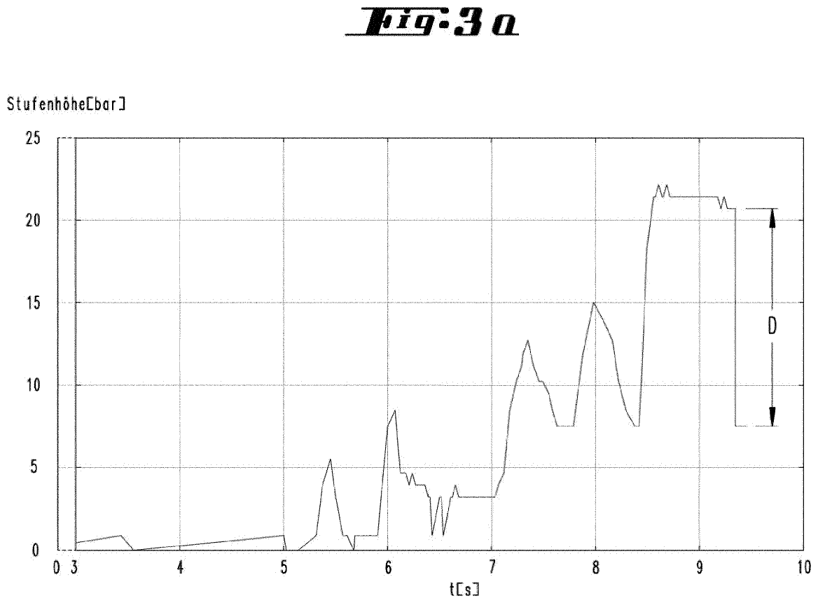

According to FIG. 3, in which the pressure is plotted on the ordinate and the time is plotted on the abscissa, this results in a certain pressure increase that also shows the workpiece contact with the pressing jaws at a point A, but this aspect is presently not of interest. The pressure continues to increase, typically more significantly than prior to the workpiece contact, up to a point B. The certain working force is reached at this point B and no higher working force actually is required anymore.

A characteristic change in the respective rise S or S′ of the pressure curve occurs after point B and, with respect to an individual step of the pressure value that becomes evident in the enlarged detail according to FIG. 3, a characteristic increase of the step height H occurs relative to a step height h prior to reaching point B.

In the exemplary embodiment, this characteristic value of the step height H is used for detecting that the certain working force has been reached and for using reaching of the step height H as a signal for terminating the certain working process. A certain tool value, which is used for comparison with an actually measured tool value and exceeding (or optionally also falling short) of which is (also) used as a signal of the certain working process, may be stored in a memory of the data processing device and/or the control device. The stored tool value may be an absolute value such as the described step height H or also a relative value that specifies a percentile limit such as 10% or 20%, for example, with respect to exceeding a prior step height h (or multiple averaged step heights).

The stored limiting value may also be a value for the aforementioned rise S′ such that the respectively calculated rise can be compared thereto.

As a mere example, the dashed representation in FIG. 3 shows how the working process would continue, in this case up to a point C that represents reaching the general working force, if no termination would be carried out at the certain working force.

In the exemplary embodiment, the step-like progression of the pressure curve is caused by the piston pump used. A higher pressure stage is reached when the piston of the pump moves upward, wherein this pressure is maintained or slightly drops during the return of the piston of the e pump until the pressure is once again increased during the next upward movement of the piston of the pump. Such a piston pump usually operates with a frequency of >1/second. Since the frequency of the measurement of the tool value, in this case the hydraulic pressure value, at least corresponds to the frequency of the piston pump in this exemplary embodiment, the operation of the pump can be measured with a very high resolution, i.e. with a resolution that in this case corresponds to one individual pressure stage generated by the piston movement of the piston pump. The measurement with respect to the absolute value of a pressure stage or the level of the pressure stage is carried out by comparing the values at a comparable point in time. This takes place, for example, either at the beginning of a piston stroke of the pump or at the end of a (forward) piston stroke of the piston pump (if such a piston pump is used). The actually measured pressure value is compared with the stored absolute value which is also the certain tool value.

In FIG. 3a, a level of the pressure stages measured in an exemplary hand-operated pressing tool is plotted as a function of the time. According to this figure, an absolute level of approximately 22 bar is reached at the end of pressure the stage (after approximately 9 seconds). Reaching this predefined absolute value (which may be characteristic for a certain hand-operated pressing tool as described in greater detail below) therefore can be used for terminating the working process.

FIG. 3a furthermore shows a pressure stage that follows the certain predefined absolute level of the pressure stage (and is plotted on the abscissa to the right of “9”), wherein this ensuing pressure stage occurs once the return valve has been opened as a result of the termination of the certain working process.

With respect to the pressure stages according to FIGS. 3, 3a, it has also been shown that a high pressure stage that leads to a termination has a certain absolute value, which practically is not dependent on the articles to be pressed, but rather should be considered as a constant of a certain tool. In a specific hydraulically operated pressing tool, this constant may lie, for example, between 15 and 25 bar, specifically between 20 and 22 bar.

With respect to FIG. 3a, the progression of the pressure curve after reaching second 9 is essential in the present context. After the return valve has been opened, the pressure evidently drops significantly and the resulting drop value D is used for the evaluation in this case. Once this drop value D is measured by a pressure sensor, the control uses this measurement for initiating the deactivation of the electric motor acting upon the pump.

It has also be determined that the aforementioned absolute value or another corresponding absolute value of a tool of this type is only reached f all required components of the tool, e.g. a return valve, an electric drive, etc., are in proper working order. The aforementioned level is no longer reached once wear has taken place, but a reliable pressing operation can still be achieved because the usual increase to the permitted maximum pressure value (to the general working force) occurs in this case and a termination of the working process can take place based on reaching the general working force.

Furthermore, this correlation can also be used for prompting the user to check the tool if the general working force has been reached once or multiple times. With respect to additional details on this subject, we refer to aforementioned US 2019/0 030 698 A1.

The termination of the certain working process is initiated by opening a return valve while the electric motor 11, which in the exemplary embodiment drives the pump 5, initially continues to operate. The electric motor and therefore the hydraulic pump are deactivated after the return valve has been opened. A pressure drop, e.g. in accordance with the pressure drop D illustrated in FIG. 3a, therefore initially occurs. Since such a pressure drop D practically always occurs in a cutting tool once the cutting process is completed, a thusly controlled device can also be readily used for a cutting process without requiring a change in the control. For example, the return valve used may be a magnet-actuated return valve of the type described in DE 10 2015 102 806 A1 (US 2018/0 236 649 A1). The content of this application is hereby fully incorporated into the disclosure of the present application, namely also for the purpose of including characteristics of the cited older application into claims of the present application.

The actuation of a return valve for initiating the termination of the working process in a hydraulic pressing tool is now described in greater detail with reference to FIGS. 4 to 8.

Analogous to the hydraulic pressing tool illustrated in FIG. 1, the hydraulic pressing tool illustrated in FIGS. 4 to 8 comprises the electric motor 11, which is not illustrated in greater detail in these figures, the hydraulic medium reservoir or tank 4 and the pump 5.

The hydraulic pressing tool illustrated in FIGS. 4 to 8 furthermore comprises the hydraulic piston 7, which can be moved relative to the hydraulic cylinder 6 by being acted upon hydraulically.

Hydraulic medium is pumped into the hydraulic cylinder 6 by the pump 5 in order to carry out a working process. The hydraulic cylinder 6 furthermore has a return line 20, through which the hydraulic medium can flow back into the hydraulic tank 4 via the return valve 21.

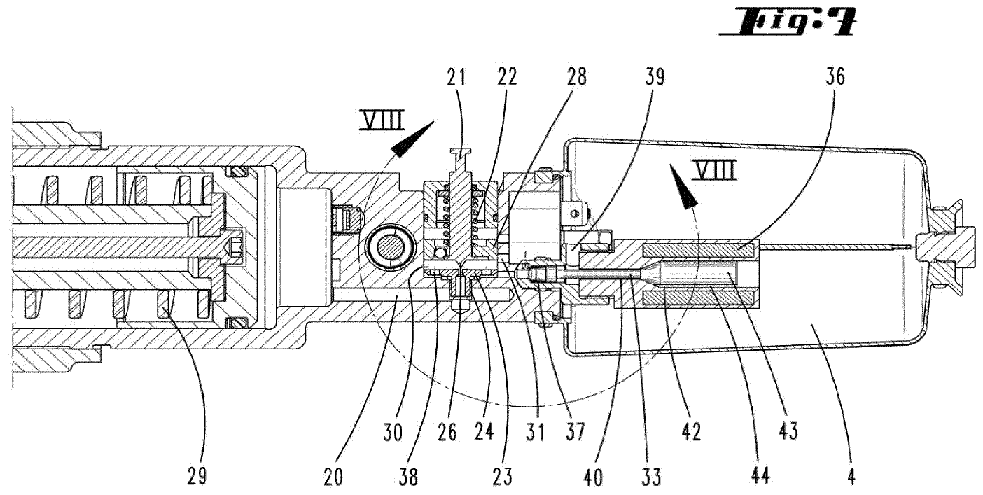

FIGS. 4 and 7, in particular, show that the volume in the hydraulic cylinder 6 changes with the working state of the hydraulic hand-operated pressing tool 1. In the illustration according to FIG. 2, the hydraulic piston 7 is in a different position than in FIG. 1. The hydraulic piston 7 moves back in the direction of its starting position according to FIG. 1 after the return valve 21 has been opened (FIG. 7), wherein the return valve can initially be opened by the control upon the completion of the certain working process or its initiation, respectively.

The electric motor 11 for operating the pump 5 and therefore for displacing the hydraulic piston 7 in the direction of a working position is activated by a switch 17 that is realized, for example, in the form of a hand-actuated pushbutton. The power supply of the electric motor 11, as well as the power supply of the aforementioned switching/control electronics and, if applicable, other electric or electronic components of the tool, is realized by an accumulator of the tool, which is not illustrated in FIGS. 4 to 8, or by an electric cable for producing a connection to the power grid.

The return valve 21 is in the closed valve position pressed into the valve seat by a pressure spring 22. The valve seat specifically includes, for example, of a screw-in part 23 that is screwed into the housing of the hydraulic hand-operated pressing tool 1 by a thread 24.

A flow-through bore 25 is provided in the valve seat, if applicable in the screw-in part 23. This flow-through bore is fluidically connected to the return line 20.

Due to the narrow cross section of the flow-through bore 25 in the valve seat and the prestress generated by the pressure spring 22, the return valve 21 basically only opens when a certain activation pressure is exceeded. The activation pressure amounts, for example, to 600 or 700 bar. This activation pressure corresponds to reaching the general working force.

After the return valve 21 has opened, the pressure of the hydraulic medium is no longer applied to only the surface corresponding to the cross-sectional area of the flow-through bore 25, i.e. a partial piston surface formed, for example, by a valve needle 26, but rather to the entire surface facing the hydraulic space (particularly the hydraulic cylinder 6), i.e. the lower surface 27 of the return valve piston 28 of the return valve 21 comprising the valve needle 26. Consequently, the opened return valve 21 is already held in the open position by a very low pressure in the return line 20, e.g. a pressure of 2 to 5 bar. The valve needle 26 does not have to be realized in an ideally pointed manner. In any case, it is preferably realized conically.

During the return of the hydraulic piston 7, this low pressure is generated, for example, by a spring 29 that acts upon the hydraulic piston 7 and stresses the hydraulic piston 7 into the end position.

The pressure is once again significantly lower downstream of the flow-through bore 25 referred to a discharge flow direction. At the beginning of the return of the hydraulic piston 7, for example, the pressure particularly amounts to only ¾ or less of the pressure upstream of the flow-through bore 25 or the valve seat, e.g. to approximately half in practical applications. However, this pressure difference is then essentially equalized and typically only comparatively low soon after the return of the hydraulic piston 7 begins.

After the return valve 21 opens, the space 30 that follows the flow-through bore 25 and extends up to the lower surface 27 of the return valve piston 28 is included in the hydraulic space. The hydraulic medium then flows into the hydraulic tank 4 through a discharge opening 31. The space 30 is also referred to as valve space above and below.

In the closed state of the return valve 21 according to FIGS. 4 to 6, an axial bore 32 that extends through the lower surface 27 and is secured, for example, by a check valve allows additional hydraulic medium to flow out of the hydraulic tank 4, particularly in order to simplify a return of the pressure booster piston 33.

Without additional any measure, the hydraulic pressure or activation pressure lifting the valve needle 26 out of the valve seat therefore corresponds to reaching the general working force.

Due to the described termination of the certain working process upon reaching the characteristic change of the tool value, however, the return valve 21 is displaced into its open position without the hydraulic pressure required for lifting the return valve 21 necessarily being applied to the hydraulic piston 7.

With respect to the exemplary embodiment described in FIGS. 4 to 8, another line 34, which in the operating state is filled with hydraulic fluid, may for this purpose be provided in assignment to the hydraulic space following the flow-through bore 25 in the discharge flow direction. This line 34 continues in a hydraulic medium cylinder 35, in which the aforementioned pressure booster piston 33 can be displaced, e.g. linearly. The line 34 could also be realized shorter than shown or even omitted.

A linear movement of the pressure booster piston 33 in the hydraulic medium cylinder 35 or in the line 34 can be respectively achieved by an electrically controllable operating magnet 36. The movement of the pressure booster piston 33 caused by the activation of the operating magnet 36 takes place, for example, against the force of a return spring 37 that acts upon the pressure booster piston 33.

The line 34 hydraulically forms part of the space 30 via bores 38 that are provided, for example, in the screw-in part 23 and aligned, for example, in the direction of displacement of the return valve 21.

In the installed state, the screw-in part 23 does not directly abut on the facing housing wall such that hydraulic medium moved by the pressure booster piston 33 can readily flow out of the line 34 and into the part of the space 30, which is formed downstream of the valve seat referred to the discharge direction of the hydraulic medium, through the bores 38.

One or multiple tool values such as the pressure in the hydraulic medium or the level of the motor current of the electric motor is/are measured and evaluated with respect to the aforementioned characteristic change while a working process is carried out.

When the characteristic change defined by a comparison value is reached, a corresponding signal is generated in the control and leads to an activation of the operating magnet 36, but at the same time (initially) allows the continuing operation of the electric motor 11.

The pressure booster piston 33 is abruptly displaced into the advanced position according to the illustrations in FIGS. 14 and 15 against the force of the preferably provided return spring 37 as a result of the activation of the operating magnet 36. This displaces the pressure booster piston in 33 very tight, practically circumferentially sealed interaction with the hydraulic medium cylinder 35 of the line 34. Hydraulic medium located in front of the pressure booster piston 33 is displaced toward the return valve 21 in a direction of displacement of the pressure booster piston 33 and therefore into the space “downstream” of the flow-through bore 25 in the exemplary embodiment shown. With respect to the closed state of the return valve 20, it is therefore displaced into the space formed by the lower surface 27 and the assigned side of the screw-in part 23, as well as a part of the cylinder, in which the return valve 21 is accommodated. This concerns the aforementioned space 30 or valve space. This valve space is thereby acted upon in the sense of a diminution. This leads to a brief pressure increase in the line 34 acting upon the lower surface 27 of the return valve 21. As a result of the action upon the diameter area of the lower surface 27, which is significantly larger than the cross-sectional area of the flow-through bore 25 in the valve seat, the return valve 21 can already be lifted by building up a pressure of only a few bar, e.g. 2 to 5 bar. This pressure is (initially) reached solely due to the piston-like displacement of the pressure booster piston 33.

Such a design of a hydraulic pressing tool particularly makes it possible to react very advantageously and quickly to the described reaching of the characteristic change in the form of a signal for terminating the certain working process.

The valve needle 26 is thereby lifted off the valve seat such that the hydraulic medium can flow back from the hydraulic cylinder 6 into the hydraulic tank 4, wherein the return valve 21 can be held in the raised position until the hydraulic piston 7 has reached the end position according to FIG. 1 and the hold-open pressure for the return valve 21 therefore is not reached.

The pressure increase on the return valve 21 by the pressure booster piston 33 acts initially. As the return valve 21 is lifted, which involves producing a connection between the space 30 and the discharge opening 31, as well as simultaneous opening of the flow-through bore 25, the pressure prevailing due to the return of the hydraulic piston 7 acts upon the return valve 21.

The electric activation of the operating magnet 36 may initially also take place in a pulse-like manner such that the pressure booster piston 33 is after its complete forward stroke almost suddenly located in the advanced position according to FIG. 7. The pressure booster piston 33 also remains in this position as long as acted upon during the regular execution of a working process, i.e, particularly when no premature termination of the return of the moving part is desired as it can basically also be realized with the described design.

The pressure booster piston 33 can prematurely move back into its starting position due to a likewise premature the activation of the operating magnet 36 prior to the completed return movement of the hydraulic piston 7. The associated enlargement of the valve space 30 can ensure such a pressure drop that the return valve 21 can thereby be closed in the desired manner. In this way, a regularly adjusted starting position an individually changed starting position, e.g. by holding an actuating switch in the depressed position, can be set for another working process.

As the pressure booster piston 33 carries out a return movement, for example, a flow path from the hydraulic tank 4 into the valve space 30 simultaneously opens in order to supply the valve space 30 with the hydraulic medium required for allowing the aforementioned return movement of the pressure booster piston 33. Hydraulic medium no longer can flow into the space 30 via the valve seat as soon as the return valve 21 is closed again. This flow path may be formed by a check valve that is arranged in the valve piston and/or a connecting path from the hydraulic tank 4 to the line 34. In addition, a return movement of the pressure booster piston 33 may at the same time form an (additional) discharge path for hydraulic medium into the hydraulic tank 4 via a line section 39 being released by the returning pressure booster piston 33. This may additionally or alternatively also be realized via a receptacle 40 for a piston shaft 41 of the pressure booster piston 33. Hydraulic medium can directly flow into the hydraulic tank 4 via this discharge path and, for example, the adjoining widened space 42, in which an actuating piston 43 of the pressure booster piston 33 is located.

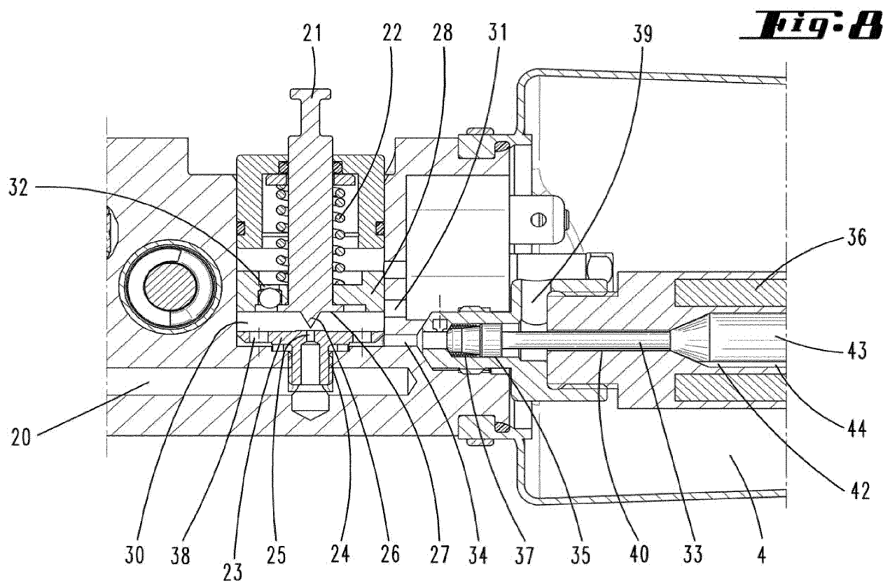

In the actuated state according to FIGS. 7 and 8, it is also important that a front surface of the actuating piston 43, which in this case is designed conically, directly abuts on the assigned wall. On the other hand, the actuating piston 43 does not completely fill out t the widened space 42 rearward thereto. In fact, a flattening or the like on one of its sides also results in a clearance 55 in the widened space 42 in the advanced state according to FIG. 7 or FIG. 8 occurring upon actuation.

It would also be possible that a forward movement of the hydraulic piston 7 into the working position only continues as long as the user actuates the switch. In an embodiment, a signal that leads to an activation of the operating magnet 36 and therefore to a pressure increase in the space 30 by the pressure booster piston 33 is generated when the switch is released (also prior to reaching the certain working force). Releasing the switch accordingly results in the displacement of the return valve 21 into the open position, which insofar can also lead to an automatic return of the hydraulic piston 7 into the end position. Nevertheless, the aforementioned termination of the certain working process upon reaching the characteristic change in the tool value can still be realized if the switch is continuously held in the depressed position.

The pressure booster piston 33 may be arranged such that it is directed transversely to the return valve 21. The longitudinal axes of the pressure booster piston 33 and the return valve 21 preferably can intersect outside the respective extending regions. This promotes a desired compact construction.

According to the exemplary embodiment shown, it would furthermore be possible that the operating magnet 36 or the corresponding component section protrudes into the hydraulic tank 4 and is thereby bathed in the hydraulic medium.

After the return valve has been opened by the control, the measurement of the pressure in the hydraulic medium is carried on continuously. This takes place within the above-described very short time intervals. Accordingly, the control detects after a very short period of time that the pressure has significantly dropped, if applicable in accordance with a predefined limiting value that the pressure has exceeded. The control thereupon initiates the deactivation of the electric motor acting upon the pump, if applicable in combination with other measured values as initially described.

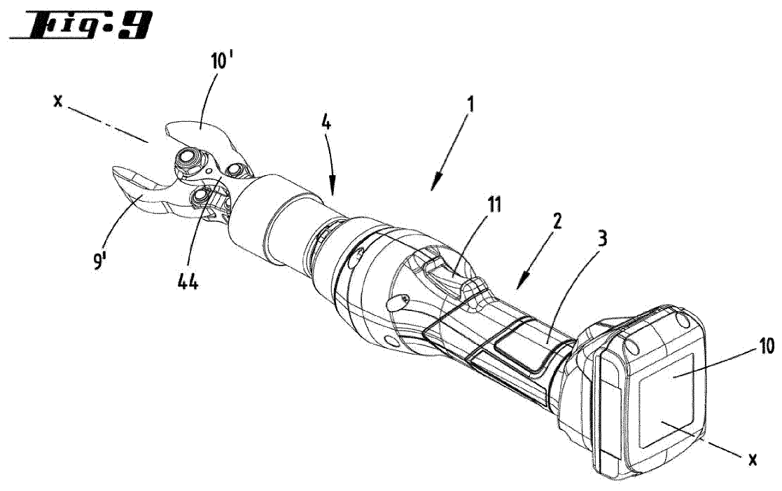

FIG. 9 shows a tool with two working jaws 9′ and 10′ that can be pivoted relative to one another and are held in a mounting part 54 of the tool. The working jaws 9′ and 10′ can be moved between an open position, which is illustrated in FIG. 9, and a closed position. The working jaws are realized in the form of cutting jaws in the exemplary embodiment shown. They can be moved until their cutting edges abut on one another or, according to another embodiment, move past one another in order to complete the cutting operation.

In this case, it would be possible to detect the closed position of the jaws, working i.e. the aforementioned abutment of the cutting jaws or the beginning of the movement of the cutting jaws past one another or even an abutment of pressing jaws, based on a position of the working jaws relative to the mounting part and to use the detection of the closed position of the working jaws as a signal for opening the return valve and subsequently deactivating the motor.

The detection of the closed position may be realized, for example, by sensors that are provided on both jaws and make it possible to detect a certain alignment of the respective jaw relative to the mounting part 54, in which a sensor may also be provided.

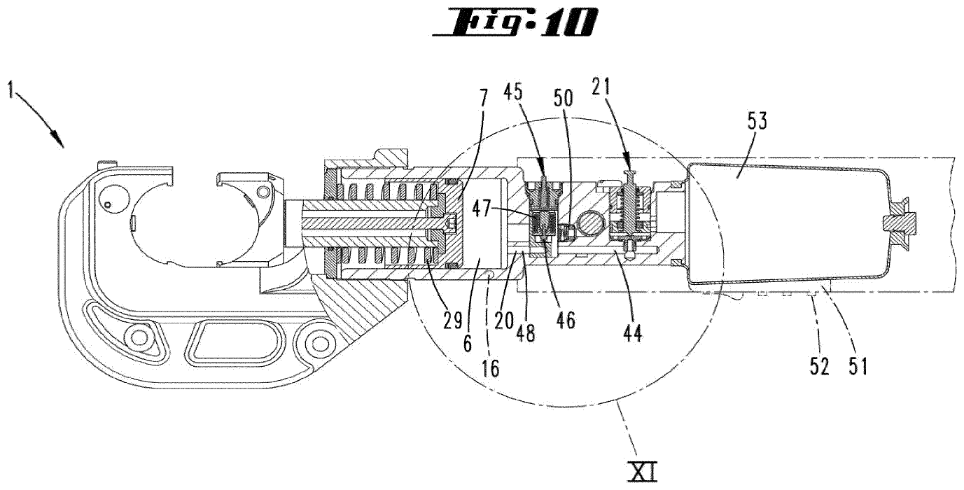

In the tool illustrated in FIGS. 10 to 13, a block 45 is provided in the hydraulic space arranged upstream of the return valve 21 referred to the inflow direction, namely in a (second) line section 44. This block 45 may be realized in the form of an electrically actuated solenoid valve.

In the exemplary embodiment shown, the block 45 in the form of a solenoid valve is composed of a linearly displaceable blocking piston 46 with a conical blocking surface and an electrically controllable operating magnet 47.

The block 45, particularly the blocking piston 46, is arranged so as to protrude into the return line 20. When the block 45 is activated, the blocking piston 46 is suitable for dividing the return line 20 into a first line section 48 between the hydraulic piston 7 and the block 45 and the second line section 44 between the block 45 and the return valve 21 viewed in the backflow direction of the hydraulic medium.

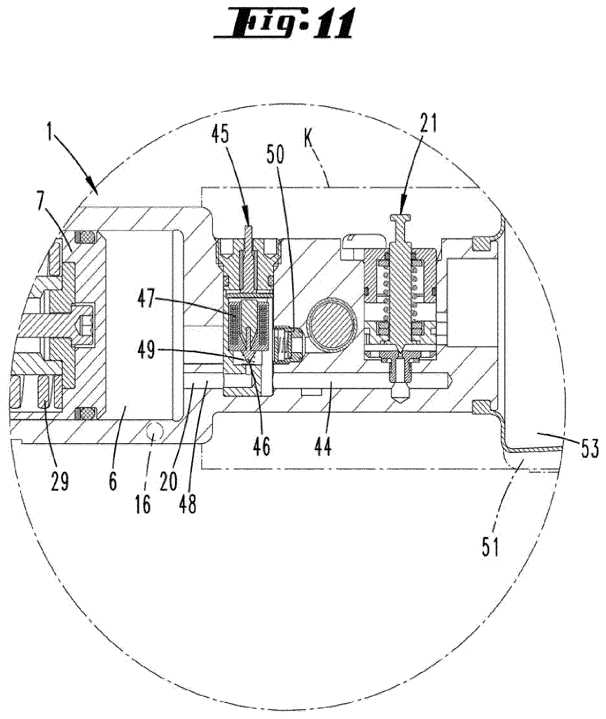

In the embodiment, the blocking piston 46 is stressed from its valve seat position, in which a separation between the first and the second line section is achieved, into an open position. For this purpose, a return spring 49 may be provided as shown (see, for example, FIG. 11) in order to generate the corresponding prestress. The return spring 49 particularly is realized in the form of a pressure spring.

The infeed of hydraulic medium for realizing the forward displacement of the moving part, i.e. the hydraulic piston 7, in the direction of the working position takes place in the region of the second line section 44 while the block 45 is opened. A check valve 50 furthermore is provided at this location.

The tool may furthermore be equipped with an adjusting device 51, by which the maximum working pressure applied to the moving part or the hydraulic piston 7 can be preadjusted. In the exemplary embodiment shown, a multitude of pushbuttons 52 is provided for this purpose, wherein defined pressure values are stored for said pushbuttons 52. The adjusting device accordingly makes it possible to adjust and thereby change the aforementioned general working force.

In contrast to the tool-specific first general working force, it would also be possible to output a message or a signal upon reaching a second general working force, which is adjusted lower than the tool-specific first general working force, wherein said message or signal informs the user that the second adjusted working force has been reached and therefore is insufficient for the intended operation. In this context, a deactivation should also take place upon reaching the characteristic change, which typically corresponds to a pressure that is lower than the pressure corresponding to the second general working force. However, since there is no risk of damaging the tool upon reaching a general working force that was changed from the first to the second general working force by the adjusting device, it is in this case not necessary, although generally possible and optionally implemented, to deactivate the tool as a whole or to output a warning message to the effect that an inspection in a service center or the like is required when the tool-specific first general working force is reached.

The adjusting device 51 makes it possible, for example, to select that the return valve is (already) opened in the above-described manner upon reaching a preselectable working pressure of 200 or 300 bar, which corresponds to the second general working force, rather than upon reaching the usual working pressure, for example, of 600 bar, which corresponds to the first general working force.

A corresponding signal is generated upon reaching the characteristic change and leads to an activation of the operating magnet 47 of the block 45.

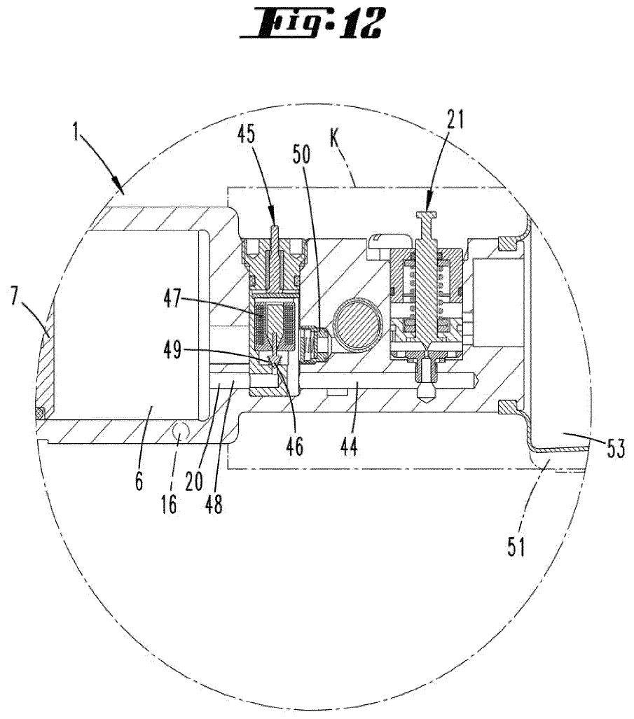

As a result of the activation of the operating magnet 47, the blocking piston 46 is abruptly displaced into the advanced position according to FIG. 12 against the force of the preferably provided return spring 49. The conical sealing surface of the blocking piston 46 thereby moves against the facing opening edge of the first line section 20 in a sealing manner.

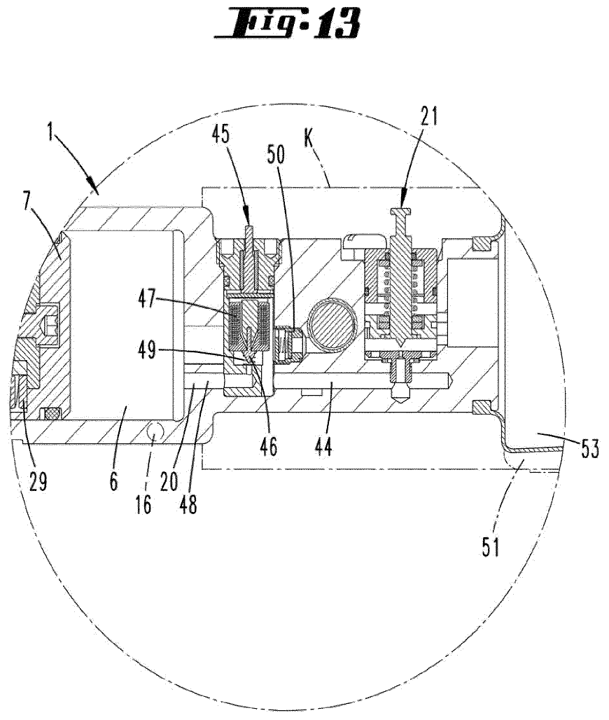

The hydraulic medium, which subsequently is still pumped—preferably via the check valve 50—from the reservoir 53 into the second line section 44, causes the pressure in the second line section 44 to correspondingly increase beyond the pressure value prevailing in the first line section 48 (which practically is identical to the pressure value in the return line 20 and the hydraulic cylinder 6). Due to the very small volumetric capacity for hydraulic medium, which essentially is formed solely by the second line section 44, the activation pressure for displacing the return valve 21 into the open position (FIGS. 12 and 13) is reached within a very short period of time, e.g. within a fraction of a second or potentially even within 2 to 5 ms.

After the pressure-induced displacement of the return valve into the open position, the operating magnet 47 of the block 45 drops due to a detected pressure drop in the second line section 44. The blocking piston 46 is displaced into the open position and therefore lifted off the valve seat, particularly in a spring-loaded manner, such that the hydraulic medium can flow back from the hydraulic cylinder 6 into the hydraulic medium reservoir 53, wherein the return valve 21 is held in the raised position until the moving part or the hydraulic piston 7 is displaced into the end position. However, additional intervention would basically also make it possible to stop the return of the hydraulic piston 7 at a certain point and to begin another working process from this point.

The displacement of the blocking piston 46 into the open position can take place in different ways. The operating magnet 47 may be designed so as to apply such a low force to the blocking piston 46 that the pressure difference generated by the blocking piston 46 between the pressure prevailing in the hydraulic cylinder 6 and the pressure prevailing in the second line section 44 presses [text missing] into the open position after the return valve 21 has opened regardless of whether the blocking piston 46 is still acted upon by the operating magnet 47. This may already occur, for example, at a pressure difference of 1 bar or more. This displacement into the open position is also desirable and required because outflowing hydraulic medium could in an excessively long closed position once again lead to the pressure in the second line section 44 falling short of the pressure, at which the return valve 21 closes. The operating magnet 47 furthermore may be acted upon in a time-controlled manner. When closing of the block, in this case specifically the blocking piston 46, is initiated, the action upon the operating magnet 47 required for this purpose may take place for a predefined period of time, which in this case may also lie in the range of milliseconds to tenths of a second. For example, if the aforementioned force acting upon the blocking piston 46 is adjusted correspondingly low as already mentioned above, the blocking piston 46 already can be moved back into an open position by the aforementioned pressure difference regardless of whether the operating magnet 47 is still acted upon. The opening force acting upon the blocking piston naturally is also dependent on the surface area blocked by the blocking piston at the transition from the first line section to the second line section 48. This is accordingly also chosen such that the aforementioned opening takes place, for example, automatically regardless of an action upon the operating magnet 47.

The pressure increase on the return valve 21 due to the blockage of the return line 20 by the block 45 may act initially. Once the return valve 21 is lifted and the block 45 is subsequently displaced into the open valve position, the pressure prevailing due to the return of the moving part 4 acts upon the return valve 21.

For an understanding of the different values mentioned here, as far as not evident from the explanation at the specific part of the application above, where they are used, are further explained as follows.

A pressure value addressed here is in its usual meaning a single pressure value recorded. In a specific case the pump is a piston pump and the pressure values therefore do show in a displayed chart a stairs-like curve.

In case the pump is a piston pump, the displayed stairs-like curve shows a number of stairs, each having a stair height. The individual stair height H, after the certain working force has been reached (third section as explained below), therefore, is a characteristic value.

A pressure increase in a working process results in a first section of time of the working process in a moving of one or more, as a rule two tool parts, such as pressure jaws or cutting jaws, together. Second, in a second section of time, they will be both in contact with a workpiece and a further increase in pressure will result in modifying the workpiece. Third, in a third section of time, a further increase in pressure will no more result in modifying the workpiece but the e.g. pressure jaws are then lying against each other and the further increase in pressure will only result in elastically deformation of parts of the tool itself, especially of the pressing jaws in the given example. Therefore a height H of steps, e.g. given in a chart, once such third section has started, will only result from values, here elasticity values, of the tool itself, irrespective of which kind of workpiece has been worked on before in the second section. Therefor the height of one or more steps in the third section depends only from tool own values. Such height can therefore be regarded as a certain tool value. Obviously, it is only a question of what to watch in this respect, one or more single absolute height values or an average of a plurality of values (height values), they all represent such certain tool value.

An actually measured tool value is a pressure value actually measured during a working process.

A stored tool value (which may also be an absolute value or a relative value) is a certain tool value stored in a memory of the tool, for comparison purposes. It will be evident, that such stored certain tool value does not need to be a before actually measured value. Since the certain tool value is necessarily higher than a tool value of the second section, one can also determine the certain tool value or more precisely a threshold after which is to assume that the certain tool value is reached by a factor of a step height h in the second section. This is the relative value. The tool value of the third section and therefore also the certain relative tool value, can obviously be represented as well by an increase of pressure (corresponding to a step height H) rather than by single pressure values (single step height H).

The stored limiting value (which may be a value for the rise, i.e. the increase of pressure/step height H) is the same as the stored tool value, which can be a stored increase of pressure, also addressed as rise (of pressure).

The tool value, in case being the hydraulic pressure value, is the absolute value of a pressure measured.

A predefined absolute value is the same as a certain tool value

A step height, causing a termination of a working process, has a certain absolute value which is the same as the certain tool value.

A tool contemplated here can have a valve which (only) opens as a reaction of a hydraulic pressure reached. This valve is also addressed as return valve. It allows the hydraulic medium to flow back into the reservoir. A possible regular work progress may be designed such that the pressure in the hydraulic medium is as long increased as the return valve has not opened yet. Once the return valve opens, the hydraulic pressure drops immediately. The pressure sensor will also record pressure values during and after the opening of the return valve. A pressure value recorded after opening of the return valve, therefore, will be remarkably lower than a value recorded before opening. Such value resulting from a measurement after opening of the return valve is therefore also addressed as resulting drop value.

The aforementioned absolute value or another corresponding absolute value of a tool of this type is the same as the certain tool value.

During a certain working process, the measured pressure values of the pressure in the hydraulic medium change once a further increase in pressure depends only on the tool, which means once the before mentioned third section is reached. The crossing from the second to third section is also addressed the characteristic change of a tool value (change from step height h to step height H).

The pressure in the hydraulic medium or the level of the motor current of the electric motor are each also addressed as tool values. Either of them can be used, alone or combined, for analyzing the tool.

A comparison value is a stored tool value.

The characteristic change in the tool value is the same as a characteristic change of a tool value.

A predefined limiting value, watched whether exceeded by the pressure, is the certain tool value. The control thereupon initiates the deactivation of the electric motor acting upon the pump, if applicable in combination with other measured values which can be especially the level of motor current.

Defined pressure values which are stored are values at which a certain working process shall terminate.

Some embodiment has a first line section and a return line. The pressure value prevailing in the first line section (which practically is identical to the pressure value in the return line) is a pressure value measured in respectively the respective line or line section

The certain working force is the working force at the end of the second section.

The general working force is the working force predefined by a structural limit of the tool, also addressed as a tool-specific first general working force.

A second general working force can be given at a specific tool at which the user can choose a working force lower than the general working force, at which any working process shall terminate (if not earlier a termination was caused e.g. by a change from a second to a third section).

### LIST OF REFERENCE SYMBOLS

1 Hydraulic hand-operated pressing tool
2 Handle
3 Accumulator
4 Hydraulic tank
5 Pump
6 Hydraulic cylinder
7 Hydraulic piston
8 Return spring
9 Movable pressing jaw
10 Stationary pressing jaw
11 Electric motor
12 Pressing space
13 Article to be pressed
14 Data processing device
15 Sensor
16 Sensor
17 Switch
18 Article to be cut
19 Control device
20 Return line
21 Return valve
22 Pressure spring
23 Screw-in part
24 Thread
25 Flow-through bore
26 Valve needle
27 Lower surface
28 Return valve piston
29 Spring
30 Valve space
31 Discharge opening
32 Axial bore
33 Pressure booster piston
34 Line
35 Hydraulic medium cylinder
36 Operating magnet
37 Return spring
38 Bores
39 Line section
40 Receptacle
41 Piston shaft
42 Space
43 Actuating piston
44 Line section
45 Block
46 Blocking piston
47 Operating magnet
48 Line section
49 Return spring
50 Check valve
51 Adjusting device
52 Pushbutton
53 Hydraulic medium reservoir
54 Mounting Part
55 Clearance
A Point
B Point
C Point
H Step height
L1 Line
L1′ Line
S Rise
S′ Rise
S1 Rise
S1′ Rise
S2 Rise
S2′ Rise
h Step height

The invention claimed is:

1. A method for operating a motor-actuated tool with a hydraulic piston/cylinder arrangement in which a hydraulic medium is located comprising:
supplying hydraulic medium to apply a force to the hydraulic piston until a certain working force is reached, wherein a general working force which is greater than the certain working force can be reached upon a further supply of hydraulic medium to the hydraulic piston;
monitoring a pressure increase in the hydraulic medium between the certain working force and the general working force, wherein the certain working force results in a characteristic change of the pressure increase in the hydraulic medium;
opening a return valve in response to an indication that the characteristic change has been monitored, thereby allowing the hydraulic medium to flow into a reservoir, wherein a pressure drop in the hydraulic medium occurs after the return valve is opened and is used as a signal for deactivating the motor; and
deactivating the motor after the signal is indicated.

2. A motor-actuated tool comprising:
a reservoir having a supply of hydraulic medium therein;
a piston/cylinder arrangement to which the hydraulic medium is supplied from the reservoir, the hydraulic medium configured to apply an applied force to the piston;
a motor configured to carry out a working process during which the hydraulic medium is supplied from the reservoir to the piston;
a return valve configured to be opened to allow the hydraulic medium to flow into the reservoir;
a monitoring device configured to monitor an increase in pressure of the hydraulic medium and configured to generate a signal when a characteristic change is monitored, the signal indicating that an increase of the applied force to a certain working force has been reached; and
a control device in communication with the monitoring device,
wherein the tool allows for an increase of the applied force to a general working force that exceeds the certain working force, and wherein the control device is configured, upon the termination of the working process, to cause a deactivation of the motor and to open the return valve,
wherein the return valve is initially opened and the motor is deactivated as a result of a pressure drop in the hydraulic medium which occurs as a result of opening the return valve.

3. A method comprising:
providing a motor-actuated tool with a hydraulic piston/cylinder arrangement in which a hydraulic medium is located, wherein a working process is carried out and a certain working process requires an increase of an applied force to a certain working force, wherein the hydraulic medium is used for applying the force and the working process no longer requires any higher force after the certain working force has been reached, wherein the tool allows an increase of the force to a general working force that exceeds the certain working force, wherein reaching the certain working force results in a characteristic change of the pressure increase in the hydraulic medium, wherein a device for monitoring the pressure increase is provided and wherein reaching the characteristic change is used as a signal for terminating the certain working process after reaching the certain working force, but before reaching the general working force, and wherein the termination of the certain working process involves a deactivation of the motor used for the pressure increase in the hydraulic medium and opening of a return valve in order to allow the hydraulic medium to once again flow into a reservoir of the tool for another working process; and
initially opening the return valve upon reaching the characteristic change, thereby causing a pressure drop in the hydraulic medium, wherein the pressure drop is used as a signal for deactivating the motor.

4. A motor-actuated tool with comprising:
a motor for carrying out a working process;
a piston/cylinder arrangement in which a hydraulic medium is located;
a return valve;
a reservoir;
wherein a certain working process requires an increase of an applied force to a certain working force and the certain working process no longer requires any higher force after the certain working force has been reached, wherein the hydraulic medium is used for applying the force, wherein the tool allows an increase of the force to a general working force that exceeds the certain working force, wherein reaching the certain working force results in a characteristic change of the pressure increase in the hydraulic medium;
a device configured to monitor the pressure increase; and
a control device which is configured to use reaching of the characteristic change as a signal for terminating the certain working process after reaching the certain working force, but before reaching the general working force, and wherein the control device is configured to cause, upon the termination of the certain working process, a deactivation of the motor used for the pressure increase in the hydraulic medium and opening of the return valve in order to allow the hydraulic medium to once again flow into the reservoir of the tool for another working process,
wherein upon reaching the characteristic change, the return valve is initially opened and the motor is deactivated due to a pressure drop in the hydraulic medium, which occurs as a result of opening the return valve.

5. The method according to claim 1, wherein the tool has working jaws, which are configured to pivot relative to one another and are held in a mounting part of the tool, in order to carry out the working process, in that the working jaws are configured to move between an open position and a closed position, in that the closed position is detected due to a position of the working jaws relative to the mounting part, and in that the detection of the closed position of the working jaws is used as a signal for deactivating the motor and/or for opening the return valve.

6. The tool according to claim 2, further comprising working jaws, which are configured to pivot relative to one another and are held in a mounting part of the tool, in order to carry out the working process, the working jaws are configured to move between an open position and a closed position, in that the closed position is detected due to a position of the working jaws relative to the mounting part, and in that the detection of the closed position of the working jaws is used as a signal for deactivating the motor and/or for opening the return valve.

7. The method according to one of claim 1, wherein a second line section, which with respect to a flow direction of the returning hydraulic medium is located upstream of the return valve, is blocked by a block in order to open the return valve, and in that a pressure increase, which leads to opening of the return valve, is generated in the blocked line section due to the continuing operation of the motor.

8. The tool according to claim 2, wherein a second line section, which with respect to a flow direction of the returning hydraulic medium is located upstream of the return valve is configured to be blocked by a block in order to open the return valve, and in that a pressure increase, which leads to opening of the return valve, is generated in the blocked line section due to the continuing operation of the motor.

9. The method according to claim 7, wherein the block is prestressed into an open position.

10. The tool according to claim 8, wherein the block is prestressed into an open position.

11. The method according to claim 7, wherein the block is actuated by a magnet.

12. The tool according to claim 8, wherein the block is actuated by a magnet.

13. The method according to claim 3, wherein the tool has working jaws which are configured to pivot relative to one another and are held in a mounting part of the tool, in order to carry out the working process, in that the working jaws are configured to move between an open position and a closed position, in that the closed position is detected due to a position of the working jaws relative to the mounting part, and in that the detection of the closed position of the working jaws is used as a signal for deactivating the motor and/or for opening the return valve.

14. The tool according to claim 4, further comprising working jaws which are configured to pivot relative to one another and are held in a mounting part of the tool, in order to carry out the working process, the working jaws are configured to move between an open position and a closed position, in that the closed position is detected due to a position of the working jaws relative to the mounting part, and in that the detection of the closed position of the working jaws is used as a signal for deactivating the motor and/or for opening the return valve.

15. The method according to claim 3, wherein a second line section which with respect to a flow direction of the returning hydraulic medium is located upstream of the return valve, is blocked by a block in order to open the return valve, and in that a pressure increase, which leads to opening of the return valve, is generated in the blocked line section due to the continuing operation of the motor.

16. The method according to claim 5, wherein a second line section which with respect to a flow direction of the returning hydraulic medium is located upstream of the return valve, is blocked by a block in order to open the return valve, and in that a pressure increase, which leads to opening of the return valve, is generated in the blocked line section due to the continuing operation of the motor.

17. The tool according to one of claim 4, wherein a second line section which with respect to a flow direction of the returning hydraulic medium is located upstream of the return valve is configured to be blocked by a block in order to open the return valve, and in that a pressure increase, which leads to opening of the return valve, is generated in the blocked line section due to the continuing operation of the motor.

18. The tool according to one of claim 6, wherein a second line section which with respect to a flow direction of the returning hydraulic medium is located upstream of the return valve is configured to be blocked by a block in order to open the return valve, and in that a pressure increase, which leads to opening of the return valve, is generated in the blocked line section due to the continuing operation of the motor.

19. The method according to claim 9, wherein the block is actuated by a magnet.

20. The tool according to one of claim 10, wherein the block is actuated by a magnet.
